(19) United States
(12) Patent Application Publication
(10) Pub. No.: US 2017/0090957 A1
(43) Pub. Date: Mar. 30, 2017

(54) PERFORMANCE AND ENERGY EFFICIENT COMPUTE UNIT

(71) Applicants: Greg Sadowski, Boxborough, MA (US); Wayne Burleson, Boxborough, MA (US); Indrani Paul, Austin, TX (US); Manish Arora, Sunnyvale, CA (US)

(72) Inventors: Greg Sadowski, Boxborough, MA (US); Wayne Burleson, Boxborough, MA (US); Indrani Paul, Austin, TX (US); Manish Arora, Sunnyvale, CA (US)

(21) Appl. No.: 14/865,731

(22) Filed: Sep. 25, 2015

(51) Int. Cl. G06F 9/445; G06F 1/26; G06F 13/42

(52) U.S. Cl. CPC G06F 9/44505; G06F 13/4282; G06F 1/266

(57) ABSTRACT

Various integrated circuits and methods of making and operating the same are disclosed. In aspect, a method of operating an integrated circuit is provided. The method includes, in a compute unit that has a first lane and a second lane, executing operations with the first lane and the second lane. The first lane and the second lane are monitored for an indicator of asynchronous operation. An input voltage of one or both of the first lane and the second lane is selectively adjusted if the indicator of asynchronous operation is detected.

This invention was made with Government support under Prime Contract Number DE-AC52-07NA27344, Subcontract No. B609201 awarded by The United States Department of Energy. The Government has certain rights in this invention.

### BACKGROUND OF THE INVENTION

1. Field of the Invention

This invention relates generally to parallel computing devices, and more particularly to methods and apparatus for parallel computing.

2. Description of the Related Art

Processing units, such as graphics processing units (GPUs) and central processing units (CPUs) can be optimized for power and chip area. Conventional CPUs and GPUs usually include onboard memory, input/output logic, and processing logic. Many conventional GPUs include processing logic with one or more shaders. One conventional shader variant uses a compute unit (CU) as a computational building block for the architecture. One type of CU consists of four separate single-instruction-multiple-data (SIMD) engines. Each SIMD includes a sixteen-lane vector pipeline. This architecture provides for efficient parallel processing of huge amounts of instructions and data. Multiple CUs may be clustered together with other processor elements into a single integrated circuit.

Even in a parallel computing environment, the lanes of a CU may execute operands at different rates. For example, the last lane of a CU may finish execution a few nanoseconds later than the first lane. This is due to the fact that the execution time for a given lane depends on the size of the operand. Smaller numbers take less time to calculate than larger ones. Similarly, some arithmetic calculations take longer than others. While the magnitude of the latency for a given operand may be quite small, over time the lanes will diverge in time. The difficulty is that the slowest lane will determine the performance for all the lanes.

The present invention is directed to overcoming or reducing the effects of one or more of the foregoing disadvantages.

### SUMMARY OF THE INVENTION

In accordance with one aspect of the present invention, a method of operating an integrated circuit is provided. The method includes, in a compute unit that has a first lane and a second lane, executing operations with the first lane and the second lane. The first lane and the second lane are monitored for an indicator of asynchronous operation. An input voltage of one or both of the first lane and the second lane is selectively adjusted if the indicator of asynchronous operation is detected.

In accordance with another aspect of the present invention, a method of manufacturing an integrated circuit is provided that includes fabricating a compute unit that has a first lane and a second lane. The first lane and the second lane are operable to execute operations. At least one voltage regulator is fabricated to deliver regulated voltages to the first lane and the second lane. Instruction monitor logic is fabricated. The instruction monitor logic is connected to the first lane and the second lane, and operable to monitor the first lane and the second lane for an indicator of asynchronous operation and selectively adjust the regulated voltages to one or both of the first lane and the second lane if the indicator of asynchronous operation is detected.

In accordance with another aspect of the present invention, an integrated circuit is provided that includes a compute unit that has a first lane and a second lane. The first lane and the second lane are operable to execute operations. At least one voltage regulator is operable to deliver regulated voltages to the first lane and the second lane. The integrated circuit also includes instruction monitor logic connected to the first lane and the second lane. The instruction monitor logic is operable to monitor the first lane and the second lane for an indicator of asynchronous operation and selectively adjust the regulated voltages to one or both of the first lane and the second lane if the indicator of asynchronous operation is detected.

### BRIEF DESCRIPTION OF THE DRAWINGS

The foregoing and other advantages of the invention will become apparent upon reading the following detailed description and upon reference to the drawings in which:

FIG. 1 is a schematic view of an exemplary conventional compute unit of a conventional processor;

FIG. 2 is a schematic view of an exemplary integrated circuit including one or more compute units;

FIG. 3 is a schematic view of an alternate exemplary embodiment of a compute unit;

FIG. 4 is a schematic view of an exemplary voltage regulator circuit usable with the disclosed compute units;

FIG. 5 is a schematic view of an alternate exemplary embodiment of a voltage regulator;

FIG. 6 is a schematic view of an alternate exemplary compute unit lane;

FIG. 7 is a flow chart depicting an exemplary method of synchronizing execution among multiple compute units; and

FIG. 8 is a flow chart depicting an alternate exemplary method of synchronizing execution among multiple compute units.

### DETAILED DESCRIPTION OF SPECIFIC EMBODIMENTS

A compute unit of, for example, a central processing unit, graphics processing unit or other integrated circuit, includes multiple lanes for parallel processing operations/instructions. As the lanes perform the operations, instruction monitor logic senses for indicator(s) of asynchronous operation by the lanes, i.e., some lanes lagging behind others in completion or big operands delivered to one lane and small operands to other lanes. Input voltages to the lanes are adjusted repeatedly to try to achieve synchronous execution. Additional details will now be described.

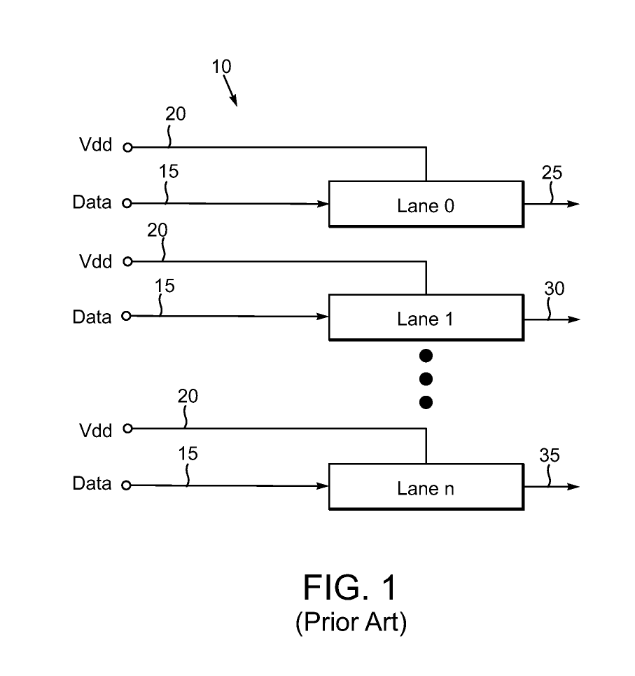

In the drawings described below, reference numerals are generally repeated where identical elements appear in more than one figure. Turning now to the drawings, and in particular to FIG. 1, therein is shown a schematic view of an exemplary conventional compute unit 10, which may be part of a processing unit, such as a GPU. The computing unit 10 consists of multiple computational lanes, lane 0, lane 1 . . . lane n (hereinafter collectively “lanes 0 . . . n”). In one embodiment, each of the lanes 0 . . . n implements a graphics pipeline that is operable, for example, to execute shader software in order to process graphic signals. Each of the lanes 0 . . . n includes a data input 15 and a system voltage input 20. The system inputs 20 are at a system voltage V_{dd}. In this system, the lanes 0 . . . n include respective outputs 25, 30 and 35. The data inputs 15 may consist of instructions and/or data and the outputs 25, 30 and 35 typically consist of data. In some embodiments, the lanes 0 . . . n can operate in parallel on a continuous stream of data and instructions on the data inputs 15. At a given moment in time, the lanes 0 . . . n may be simultaneously performing calculations but on different sized operands and using different mathematical calculations. For example, at some time t₀ lane 0 may be instructed to multiply two four bit numbers, lane 1 may be instructed to calculate the natural log of an eight bit number and lane n may be instructed to calculate the cosine of a twelve bit number. In general, smaller numbers take less time to calculate than larger numbers, and more simple arithmetic operations take less time than more complicated arithmetic operations. Therefore, it may be that the execution time for lane 0 may be less than lane n but the slowest lane will decide the performance of all the lanes 0 . . . n. Although the latency associated with the different execution times of the lanes 0 . . . n may be on the order of nanoseconds, these delays can add up over time and lead to bottlenecks in the processing of rapidly changing data, such as video frames.

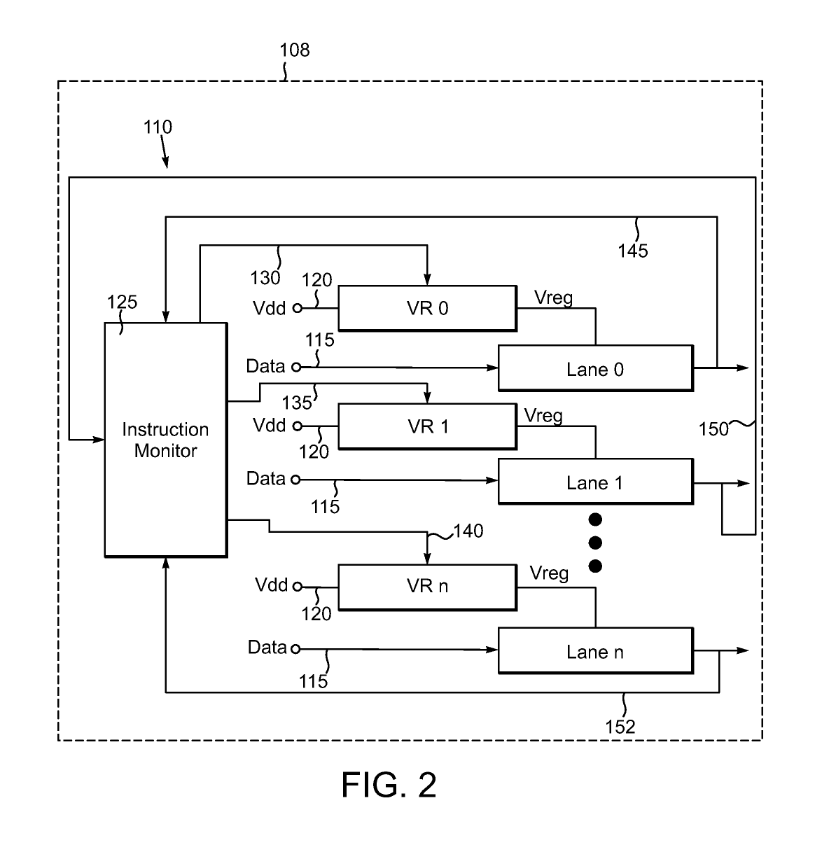

An exemplary embodiment of an integrated circuit 108 that includes one or more compute unit(s) 110 may be understood by referring now to FIG. 2, which is a schematic view. The integrated circuit 108 may be any of a variety of integrated circuits, implemented as a semiconductor chip(s) or otherwise. A non-exhaustive list of examples includes microprocessors, graphics processors, combined microprocessor/graphics processors, system-on-chips, application specific integrated circuits, memory devices, firmware or the like. The compute unit 110 may include multiple computation lanes lane 0, lane 1 . . . lane n (hereinafter collectively lanes 0 . . . n). The number of computation lanes 0 . . . n may be varied. In an exemplary embodiment, lanes 0 . . . n may total 64. Although not depicted, the lanes 0 . . . n could, in some embodiments, depending on the applicable architecture, be subdivided among two or more single-instruction-multiple-data (SIMD) engines. The lanes 0 . . . n include respective data inputs 115, which may provide data and/or instructions. In addition, the computation lanes 0 . . . n include respective voltage regulators VR 0, VR 1 . . . VR n (collectively, VR 0 . . . VR n). Each of the voltage regulators VR 0 . . . VR n is operable to deliver a regulated voltage Vreg to its corresponding lane 0, lane 1 or lane n. The voltage regulators VR 0 . . . VR n have respective voltage inputs 120, which may be at V_{dd} or some other voltage. An instruction monitor 125 is operable to deliver control signals 130, 135 and 140 to voltage regulators VR 0, VR1 and VR n, respectively. The instruction monitor 125 delivers the control signals 130, 135 and 140 to the voltage regulators VR 0 . . . VR n in response to feedback signals 145, 150 and 152 from the lanes 0 . . . n, respectively.

The instruction monitor 125 may include logic and/or code designed to examine the respective feedback signals 145, 150 and 152 and determine whether the lanes 0 . . . n have completed an instruction or operation synchronously or asynchronously. For example, assume that lane 0 receives a data and/or instructions on the data input 115 and so on for lanes 1 . . . n and that lane n is lagging in time to complete the operation. The instruction monitor 125 is operable to sense this latency between the completion of the instructions by lanes 0 and 1, and lane n by way of the feedback signals 145, 150 and 152 and deliver the appropriate control signals 130, 135 and 140 to the voltage regulators VR 0 . . . VR n to speed up or slow down the operation of lanes 0 . . . n as appropriate. Again assume that lane n is lagging behind lanes 0 and 1. In that context, the instruction monitor 125 may deliver control signals 130 and 135 to voltage regulators VR 0 and VR 1 to lower the levels of Vreg delivered to lanes 0 and 1 and thus slow them down temporarily while lane n completes the instruction. Conversely, the instruction monitor 125 might, by way of the control signal 140, increase Vreg for lane n above Vreg for lanes 0 and 1 temporarily in order to speed up the operation of lane n. This adjustment of Vreg for each of the lanes 0 . . . n may proceed on a continuous basis as new instructions and data are delivered on the inputs 115.

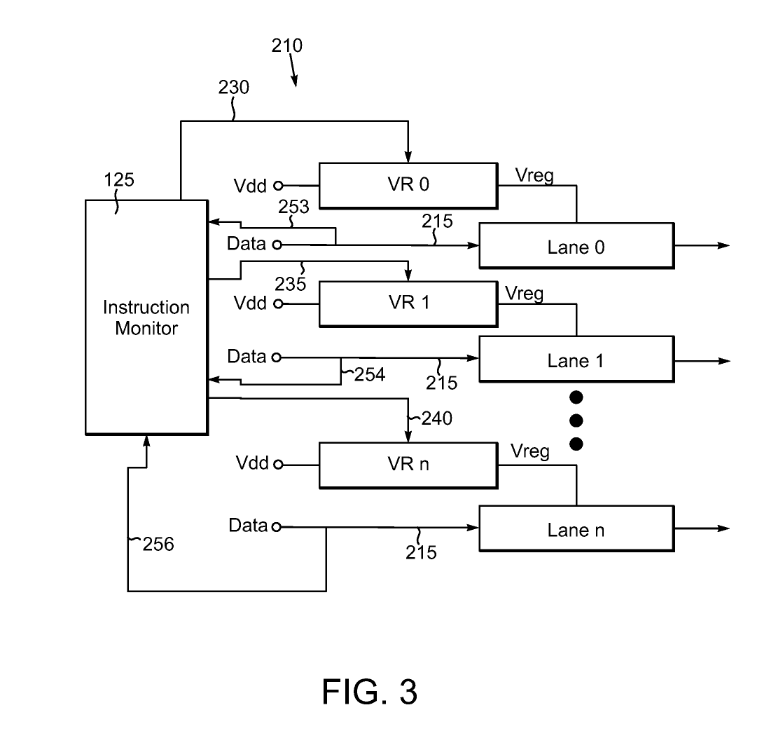

In the illustrative embodiment depicted in FIG. 2 and just described, the instruction monitor 125 examines the outputs of the compute lanes 0 . . . n looking for asynchronous completion of instructions and tasks by the various lanes and makes voltage regulator adjustments accordingly. However, in an alternate exemplary embodiment of a compute unit 210 depicted in FIG. 3, the instruction monitor 125 may look at another type of indicator of asynchronous operation. Instead of execution completion status, the instruction monitor 125 may look at the nature of the data and instructions, i.e., the operands on the data inputs 215 and make appropriate control signal inputs to the voltage regulators VR 0 . . . n in order to achieve a more synchronous operation of the compute lanes 0 . . . n. Like the embodiment of FIG. 2, the instruction monitor 125 provides control inputs 230, 235 and 240 to the voltage regulators VR 0, VR 1 and VR n, respectively. Here, however, the instruction monitor 125 includes inputs 253, 254 and 256, which are tied to the data inputs 215 of the lanes 0 . . . n respectively. In this way, when an operand is received at the data inputs 215, the instruction monitor 125 examines the operand for length and complexity and then makes a prediction as to the relative calculation times for the respective lanes 0 . . . n and based on those calculations delivers appropriate control signals 230, 240 and 250 to the voltage regulators VR 0 . . . n, respectively. For example, assume that instruction monitor 125 reads the operand at input 253 for lane 0 and the operand at input 254 for lane 1 and determines that it is more likely than not that lane 1 will complete its calculation faster than lane 0. In that circumstance, the instruction monitor 125 is operable to: (1) by way of the control signal 235 lower Vreg delivered to lane 1 so that it operates somewhat relatively slower so that lane 1 and lane 0 complete their operations at approximately the same time; or (2) by way of the control signal 230 adjust up Vreg for lane 0 to speed up its operation relative to lane 1 and thus move closer to a more synchronous instruction completion. The same type of management of the outputs of the voltage regulators VR 0 . . . n may be done for all of the compute lanes 0 . . . n in the compute unit 210. Power savings might be achieved if execution delays among lanes 0 . . . n are not acted upon immediately, but instead every so often, say after every N instructions. This applies to any of the disclosed embodiments. Note that a given lane 0 . . . n may include one or more internal clocks (not shown), which may operate at some range of frequencies. The internal clock frequency may be tied to Vreg, that is, go up automatically with an increase in Vreg and go down automatically with a decrease in Vreg. It may be possible manipulate internal clock frequency in response to operand characteristics as disclosed above while also making corresponding manipulations of Vreg.

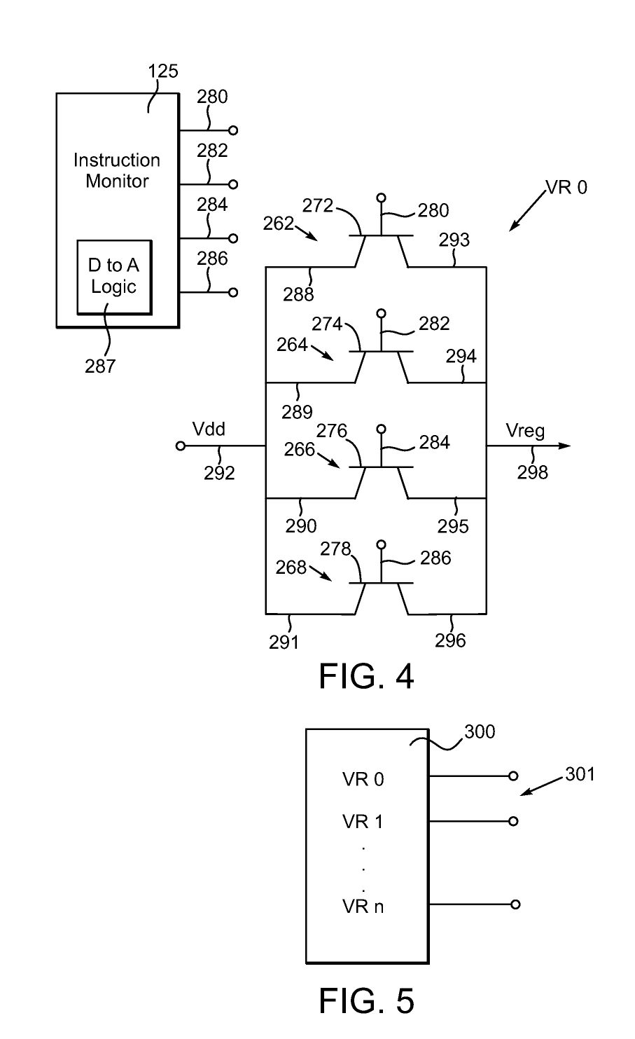

The voltage regulators VR 0 . . . n described in conjunction with the disclosed embodiments, may take on a large number of different implementations. An exemplary embodiment of a voltage regulator VR 0, which will be illustrative of the voltage regulators VR 1 . . . n as well, may be understood by referring now to FIG. 4, which is a schematic view. The voltage regulator VR 0 may consist of two or more transistors and in this illustrative embodiment four transistors 262, 264, 266 and 268. In this illustrative embodiment, the transistors 262, 264, 266 and 268 may be fabricated as field effect transistors, but bipolar transistors or other switching devices might used. Furthermore, enhancement or depletion mode may be used. The gates 272, 274, 276 and 278 of the transistors 262, 264, 266 and 268 are tied to respective control signals 280, 282, 284 and 286 output from the instruction monitor 125. Note that the multiple control signals 280, 282, 284 and 286 in FIG. 4 are represented schematically as the single control signal 130 or 230 in FIG. 2 or 3. The instruction monitor 125 may include digital-to-analog logic 287, which is operable to deliver the control signals 280, 282, 284 and 286 as logic high or low to turn on or off the transistors 262, 264, 266 and 268. The sources 288, 289, 290 and 291 of the transistors 262, 264, 266 and 268 are tied in parallel to an input 292 at Vdd. The drains 293, 294, 295 and 296 of the transistors 262, 264, 266 and 268 are tied in parallel to an output 298, which is positioned between the drains 294 and 295. With the four transistors, 262, 264, 266 and 268 selectively turned on or off by way of the control signals 280, 282, 284 and 286, any of four voltage outputs may be delivered at output 298 as Vreg. The voltage Vreg will be proportional to the Vdd at input 292 and whatever resistances (voltage drops) are associated with each of the transistors 262, 264, 266 and 268. Assume that all of the transistors 262, 264, 266 and 268 have respective resistances R₂₆₂, R₂₆₄, R₂₆₆ and R₂₆₈. Then Vreg is given by:

$${V}_{reg} = I ( \frac{1}{\frac{1}{{R}_{262}} + \frac{1}{{R}_{264}} + \frac{1}{{R}_{266}} + \frac{1}{{R}_{268}}} ) \qquad ( 1 )$$

where I is current. If a given transistor, say transistor 262, is turned off, then R₂₆₂ is zero and Vreg is given by:

$${V}_{reg} = I ( \frac{1}{\frac{1}{{R}_{264}} + \frac{1}{{R}_{266}} + \frac{1}{{R}_{268}}} ) \qquad ( 2 )$$

and so on for each combination of the transistors 262, 264, 266 and 268 that are on or off. This provides four different levels of regulated voltage Vreg. However, the skilled artisan will appreciate that if greater granularity in the levels of Vreg are required then additional transistors may be included into the voltage regulator VR 0 as desired. Of course, other regulator architecture may be used, such as buck regulators.

The disclosed embodiments have been described in conjunction with discrete voltage regulators VR 0 . . . VR n. However, the skilled artisan will appreciate that it may be possible to integrate the voltage regulators VR 0, VR1 . . . VR n into a single regulator 300 with multiple outputs 301 as shown in FIG. 5. The voltage regulator 300 is controlled by the instruction monitor (not shown) described elsewhere herein.

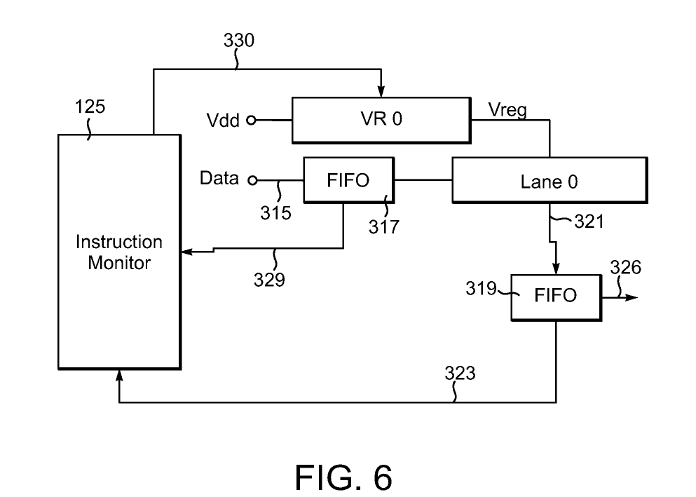

An exemplary implementation for monitoring a given compute lane for task completion and voltage regulation in view of the status of the task execution may be understood by referring now to FIG. 6, which is a schematic view. Here, only the instruction monitor 125 and one of the compute lanes, lane 0 is depicted. However, this description applies equally to the other compute lanes 1 through n depicted elsewhere herein. Here, a data input 315 to the lane 0 is first passed through a first in first out (FIFO) register 317. Optionally, a second FIFO register 319 may receive an output 321 of compute lane 0 and deliver a feedback signal 323 to the instruction monitor 125 as well as the computational output 326 of lane 0. The input FIFO register 317 provides a feedback signal 329 to the instruction monitor 125. By way of the feedback signal 329, the instruction monitor 125 continuously monitors the population of the FIFO 317 and for the other similar FIFOs (not shown) for the other lanes (not shown). If the instruction monitor 125 determines that the population of pending instructions in the FIFO 317 is larger relatively than the other lanes then the instruction monitor 125 may, by way of the control signal 330, change the level of Vreg delivered to lane 0 as generally described elsewhere herein. The instruction monitor 125 may perform a similar analysis and control signal change based on the population of the output FIFO 319 and as delivered on the feedback signal 323.

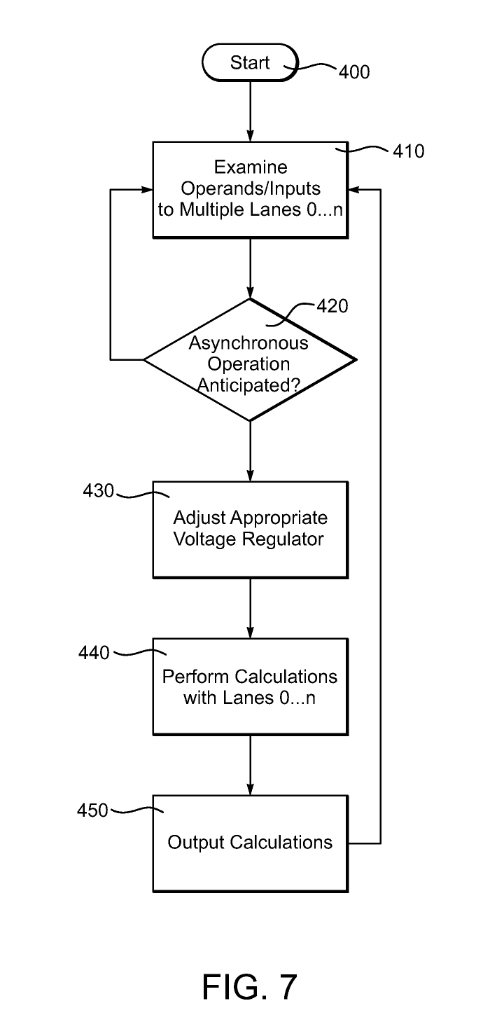

An exemplary flow chart depicting an exemplary control scheme utilizing the disclosed instruction monitoring and voltage regulation for compute lanes may be understood by referring now to FIG. 7. After a start at step 400, operands for multiple lanes are examined at step 410. This may involve the examination of the operands at data inputs 215 shown in FIG. 3 for example. If at step 420 the instruction monitor 125 depicted in FIG. 3 determines that, based on an examination of the operands at inputs 215 that the compute lanes 0 . . . n will operate asynchronously then at step 430, a voltage regulator, say VR 0 in FIG. 3, for a given lane is adjusted up or down. Next at step 440, the calculations are performed by the compute lanes 0 . . . n and the results are outputted at step 450 and a return is made to step 410.

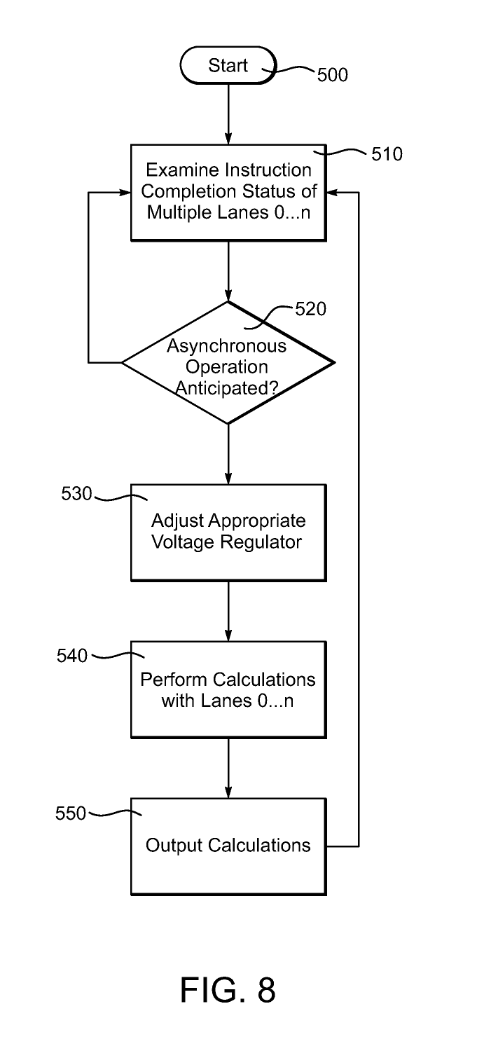

In another exemplary control scheme that utilizes an examination of the outputs of compute lanes for voltage regulation control purposes may be understood by referring now to the flow chart depicted in FIG. 8. Following a start step at 500, at step 510 the execution completion status of multiple compute lanes 0, 1 and n is examined. This may entail the FIFO polling described above in conjunction with FIG. 6. If at step 520 the instruction monitor 125 depicted in FIG. 6 determines that, based on an examination of the FIFO polling that the compute lanes 0 . . . n will operate asynchronously then at step 530, a voltage regulator, say VR 0 in FIG. 6, for a given lane is adjusted up or down. At step 520, the instruction monitor 125 in FIG. 6 determines if asynchronous lane operation is present and if so at step 530 adjusts the voltage regulator inputs to the compute lanes accordingly. If however at step 520 there is no asynchronous lane operation detected then a return is made to step 510. In steps 540 and 550, respectively, the compute lanes 0 . . . n perform the calculations and those calculations are outputted.

The integrated circuit 108 depicted in FIG. 2 and any alternative structures thereof disclosed herein may be fabricated using well-known semiconductor manufacturing techniques, such as circuit fabrication, material addition, removal, masking, etching, implanting, plating or any of the myriad of other manufacturing processes used for integrated circuits. Silicon, germanium, semiconductor-on-insulator, graphene or other materials may be used as substrate materials.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of operating an integrated circuit, comprising:
in a compute unit having a first lane and a second lane, executing operations with the first lane and the second lane;
monitoring the first lane and the second lane for an indicator of asynchronous operation; and
selectively adjusting an input voltage of one or both of the first lane and the second lane if the indicator of asynchronous operation is detected.

2. The method of claim 1, wherein the indicator of asynchronous operation comprises execution completion times of first lane and the second lane.

3. The method of claim 1, wherein the indicator of asynchronous operation comprises the lengths of operands delivered to the first lane and the second lane.

4. The method of claim 3, comprising adjusting the input voltage to the first lane to be higher than the input voltage to the second lane if the operand to first lane is longer than the operand to the second lane or adjusting the input voltage to the first lane to be lower than the input voltage to the second lane if the operand to first lane is shorter than the operand to the second lane.

5. The method of claim 1, comprising temporarily storing operands for the first lane in a first register and operands for the second lane in a second register, the indicator comprising a difference in the populations of the operands between the first register and the second register.

6. The method of claim 1, wherein the selectively adjusting the voltage comprises using a first voltage regulator to delivered a regulated voltage to the first lane and the second lane.

7. The method of claim 5, comprising using the first voltage regulator to deliver regulated voltage to the first lane and a second voltage regulator to deliver regulated voltage to the second lane.

8. The method of claim 1, comprising monitoring the first lane and the second lane using logic in the integrated circuit.

9. A method of manufacturing an integrated circuit, comprising:
fabricating a compute unit having a first lane and a second lane, the first lane and the second lane being operable to execute operations;
fabricating at least one voltage regulator to deliver regulated voltages to the first lane and the second lane; and
fabricating instruction monitor logic, the instruction monitor logic being connected to the first lane and the second lane, the instruction monitor logic being operable to monitor the first lane and the second lane for an indicator of asynchronous operation and selectively adjusting the regulated voltages to one or both of the first lane and the second lane if the indicator of asynchronous operation is detected.

10. The method of claim 8, wherein the indicator of asynchronous operation comprises execution completion times of the first lane and the second lane.

11. The method of claim 8, wherein the indicator of asynchronous operation comprises the lengths of operands delivered to the first lane and the second lane.

12. The method of claim 8, wherein the integrated circuit comprises a first register for temporarily storing operands for the first lane and a second register for temporarily storing operands for the second lane, the indicator comprising a difference in the populations of the operands between the first register and the second register.

13. The method of claim 8, comprising fabricating a voltage regulator to deliver regulated voltage to the first lane and a second voltage regulator to deliver regulated voltage to the second lane.

14. An integrated circuit, comprising:
a compute unit having a first lane and a second lane, the first lane and the second lane being operable to execute operations;
at least one voltage regulator to deliver regulated voltages to the first lane and the second lane; and
instruction monitor logic connected to the first lane and the second lane, the instruction monitor logic being operable to monitor the first lane and the second lane for an indicator of asynchronous operation and selectively adjusting the regulated voltages to one or both of the first lane and the second lane if the indicator of asynchronous operation is detected.

15. The integrated circuit of claim 14, wherein the indicator of asynchronous operation comprises execution completion times of first lane and the second lane.

16. The integrated circuit of claim 14, wherein the indicator of asynchronous operation comprises the lengths of operands delivered to the first lane and the second lane.

17. The integrated circuit of claim 16, wherein the instruction monitor is operable to adjust the input voltage to the first lane to be higher than the input voltage to the second lane if the operand to first lane is longer than the operand to the second lane or adjust the input voltage to the first lane to be lower than the input voltage to the second lane if the operand to first lane is shorter than the operand to the second lane.

18. The integrated circuit of claim 14, wherein the integrated circuit comprises a first register for temporarily storing operands for the first lane and a second register for temporarily storing operands for the second lane, the indicator comprising a difference in the populations of the operands between the first register and the second register.

19. The integrated circuit of claim 14, wherein the at least one voltage regulator comprises multiple transistors having respective inputs and outputs tied in parallel.

20. The integrated circuit of claim 14, wherein the at least one voltage regulator comprises a first voltage regulator to deliver regulated voltage to the first lane and a second voltage regulator to deliver regulated voltage to the second lane.
